(19) United States
(12) Patent Application Publication
(10) Pub. No.: US 2026/0194045 A1
(43) Pub. Date: Jul. 9, 2026

(54) A WIND TURBINE WITH A LIGHTNING CURRENT TRANSFER SYSTEM

(71) Applicant: VESTAS WIND SYSTEMS A/S, Aarhus N (DK)

(72) Inventors: Mark Rosendal STEINICHE, Hjerm (DK); Jesper HØRUP, Fårup (DK)

(73) Assignee: VESTAS WIND SYSTEMS A/S, Aarhus N. (DK)

(21) Appl. No.: 19/133,439

(22) PCT Filed: Dec. 8, 2023
(86) PCT No.: PCT/DK2023/050296

§ 371 Date: May 28, 2025

(30) Foreign Application Priority Data
Dec. 9, 2022 (DK) PA202270590

(51) Int. Cl. F03D 80/30

(52) U.S. Cl. CPC F03D 80/30

(57) ABSTRACT

A wind turbine (W) has a hub (2) rotatably supported relative to a nacelle (3) and plurality of blades (1) mounted on the hub (2). A lightning current transfer system (100) is arranged to provide a lightning current transfer path (P) from at least one of the blades (1) to the nacelle (3). The lightning current transfer system (100) has at least one electrical conductor (20) which passes through a hollow interior portion of the hub (2) between the at least one of the plurality of blades (1) and the nacelle (3). A cover (24) is provided for attenuating an electromagnetic field generated by a lightning current in the electrical conductor (20) passing within the hollow interior portion of the hub.

### FIELD OF THE INVENTION

The present invention relates to a wind turbine with a lightning current transfer system. The invention particularly relates to a lightning current transfer unit that can discharge lightning currents and static charge from a turbine blade.

### BACKGROUND OF THE INVENTION

Due to their size, wind turbines are prone to lightning strikes. The height of onshore wind turbines overshoots by far surrounding trees and buildings in order to efficiently convert wind power into electric energy. Offshore wind turbines, by their nature, overshoot the top of the body of water in the which they are placed.

If lightning strikes a wind turbine, commonly at the tip of the wind turbine rotor blade, a lightning current transfer system is typically provided to protect sensitive components such as the turbine generator and the generator shaft bearings from the high lightning current and high voltages by offering a current path with lower impedance around the sensitive areas. The lightning current transfer system may have a blade current transfer device for maintaining an electrical connection between one of a plurality of the blades and an electrical conductor as the blade rotates relative to the hub about a pitch bearing on the hub. The lightning current transfer system may have a nacelle current transfer device for maintaining an electrical connection between the hub and the nacelle as the hub rotates relative to the nacelle about the main shaft bearing.

An example solution for this problem is shown in WO2015051800A1 which discloses a lightning current transfer unit (“LCTU”) which is collectively usable for a wide variety of turbine types. Standard turbines of the type used with the LCTU of WO2015051800A1 have a hub rotatably supported relative to a nacelle, a plurality of blades mounted on the hub, and an LCTU (per blade) arranged to provide a lightning current transfer path from the blade to the nacelle via an electrical cable. The hub is relatively small compared to the nacelle so that the blade band (forming part of the blade current transfer device) around the outside of the blade root and the nacelle lightning ring (forming part of the nacelle current transfer device) on the front of the nacelle towards the hub can be positioned relatively close to each other with the electrical cable located in the space within a spinner surrounding the hub and between the spinner and the nacelle.

With the increasing drive for the generation of green energy, there is a greater need to generate power from wind energy. The power generated from wind energy is proportional to the swept area of the turbine blades so any increase in blade size should result in an increased power generation for the same wind velocity. As blade size increases components of the wind turbine may need to be adapted to compensate for this, for example for reasons of mechanical strength or the like. For example, an increase in blade length may require an increase in the hub size, blade root diameter, generator shaft diameter, nacelle height and/or width etc. and further necessitate a change in shape of these components. An increase in size of these components may lead to an increased length of the electrical cable forming part of the LCTU leading to higher impedance. A potential outcome in larger wind turbines is that should the distance of the electrical cable be increased it could result in lightning current flashing over or forming an undesirable alternative current path to ground outside of the LCTU. Such a scenario may potentially damage components in the wind turbine, such as sensitive bearings or electronic equipment.

It is therefore an objective of the present invention to provide an improved lightning transfer system for wind turbines.

### SUMMARY OF THE INVENTION

A first aspect of the invention provides a wind turbine comprising a hub rotatably supported relative to a nacelle, a plurality of blades mounted on the hub, and a lightning current transfer system arranged to provide a lightning current transfer path from at least one of the blades to the nacelle,
the lightning current transfer system comprising:
   at least one electrical conductor, wherein the electrical conductor passes through a hollow interior portion of the hub between the at least one of the plurality of blades and the nacelle; and
   a cover suitable for attenuating an electromagnetic field generated by a lightning current in the electrical conductor passing within the hollow interior portion of the hub.

The arrangement of the lightning current transfer system (“LCTS”) passing through a portion of the hub enables a shorter current path of the LCTS between the blade and nacelle than would otherwise be present if the LCTS current path passed around the exterior of the hub. For a large wind turbine with an externally routed LCTS outside the hub there may be a risk of arcing onto the hub as this may present a shortest path for the lightning current. It is important that the hub itself does not become ‘live’, even when the LCTS is passing a lightning current, as the pitch and main shaft bearings may then become live and risk damage to the bearings. Passing the LCTS through the interior of the hub, which is typically a large cast metal component and thereby forms a Faraday cage around sensitive electronic equipment often housed within the hub, presents a further problem in that the Faraday cage could become perforated by the passage of the LCTS therethrough, which could subject any sensitive electronic equipment within the hub to risk of electro-magnetic interference. The cover therefore advantageously attenuates an electromagnetic field generated by the electrical current passing through the electrical conductor of the LCTS. The benefit of this arrangement is that there is reduced or negligible electro-magnetic interference from the LCTS with sensitive components or electrical equipment disposed in the hollow interior portion of the hub. A further benefit is that there does not need to be as great a distance between those components/electrical equipment and the electrical conductor so packaging within the hub interior can be optimised.

Preferably the cover comprises electrically conductive material.

Preferably the cover comprises or consists of mild steel. Mild steel has been found by to be particularly good at reducing magnetic field strength in comparison to other electrically conductive materials. For example, a cover comprising mild steel can result in a decrease in several orders of magnitude in magnetic field strength (H measured in kA/m) where the magnetic field strength is measured at a set distance away from a lightning current passing through the electrical conductor. In comparison, other grades of steel, such as stainless and carbon steel, of a same or similar wall thickness have been found to not perform as well (although still better than without a cover).

Preferably the wind turbine further comprises electrically insulative material between the electrical conductor and the cover.

Preferably, the hub comprises electrically conductive material, and the cover and the hub are electrically connected. In other words, the cover is electrically grounded to the hub. Having an electrical connection between the cover and the hub further helps to attenuate an electromagnetic field generated by an electrical current passing through the electrical conductor.

Preferably the hub provides a Faraday cage and the cover provides an extension of the Faraday cage within the hollow interior portion of the hub to accommodate the lightning current transfer path.

Preferably the cover is a metal pipe. The cover may alternatively be metal ducting. Advantageously, using metal piping or metal ducting may reduce costs and simplify manufacture of the LCTS as “off-the-shelf” components may be employed.

Preferably the lightning current transfer path passes through a first aperture in a hub plate or a wall of the hub at a first hub location and/or passes through a second aperture in a wall of the hub at a second hub location. In an example, the first aperture is in a hub plate at a first hub location and the second aperture is in a wall of the hub at a second hub location. In another example, the first aperture is a wall of the hub at a first hub location and the second aperture is in a wall of the hub at a second hub location The first and/or second apertures may be sized approximately to the diameter of the electrical conductor. For example, the first and/or second apertures may be slightly oversized in relation to the diameter of the electrical conductor to allow room for electrical insulating material to be disposed between the aperture in the hub plate or wall of the hub and the electrical conductor. The first and/or second apertures may alternatively be sized to just accommodate the cover of the electrical conductor. Preferably, the only element that passes through the first and/or second apertures is the electrical conductor. Preferably, the first and/or second apertures are perforations in the hub plate or wall of the hub. In other words, the first and/or second apertures are small apertures relative to other larger apertures in the hub where pitch bearings or a main shaft connection flange may be located. The small apertures help to attenuate the electromagnetic field by maintaining the Faraday cage.

Preferably the cover is uninterrupted within the interior portion of the hub. This arrangement may advantageously maintain the extension of the Faraday cage

Preferably the cover is connected to the hub at the first aperture to completely surround the first aperture and/or connected to the hub at the second aperture to completely surround the second aperture. The expression “connected to the hub” means that an element, e.g. in this case the cover, can be connected to the hub plate or a wall of the hub. This arrangement may advantageously maintain the Faraday cage, preventing electromagnetic fields inside the hub whilst enabling a shorter lightning current transfer path through the hub.

Preferably, the hub comprises electrically conductive material, and the cover and the hub are electrically connected at the first aperture and at the second aperture. In other words, the cover is electrically grounded to the hub at both the first aperture and at the second aperture. This advantageously further attenuates an electromagnetic field generated by an electrical current passing through the electrical conductor and maintains the extension of the Faraday cage.

Preferably the electrical conductor is electrically isolated from the hub.

Preferably the cover is not present outside the hub.

Preferably each of the plurality of blades are rotatably mounted to the hub, and the lightning current transfer system further comprises a blade current transfer device for maintaining an electrical connection between the at least one of a plurality of blades and the electrical conductor as the blade rotates relative to the hub.

Preferably the blade current transfer device includes a blade band disposed on an interior side of the blade. Preferably, the entire blade current transfer device is disposed on the interior side of the blade.

Preferably, the electrical conductor passes through a hub plate covering an aperture between the hollow interior portion of the hub and the interior side of the blade.

Preferably the blade current transfer device includes a contact device mounted to the hub (such as on a wall of the hub or a hub plate) via an elastic bracket for pressing the contact device against the blade band. The contact device may be directly or indirectly mounted on the hub (i.e. connected to the hub by one or more intermediary components). The contact device may be substantially stationary relative to the hub (i.e. not rotating with the blade pitching motion relative to the hub) save for the motion caused by movement of the elastic bracket.

Preferably, the lightning current transfer system further comprises a nacelle current transfer device for maintaining an electrical connection between the hub and the nacelle as the hub rotates relative to the nacelle.

Preferably, the hub has a frontal area larger than a frontal area of the nacelle and the nacelle current transfer device is located within the frontal area of the nacelle.

Preferably, the nacelle current transfer device is located radially outwards of a main shaft. In other words, the nacelle current transfer device is not located within a hollow main shaft that connects to the hub. This arrangement is advantageous because the lightning current can be taken directly into a metallic frame of the nacelle and then to ground via a tower.

Preferably each blade of the plurality of blades has a respective electrical conductor, wherein each of the electrical conductors passes through the hollow interior portion of the hub between the respective blade and the nacelle.

Preferably the wind turbine comprises electronics within the hollow interior of the hub. In other words, the hollow interior of the hub comprises electrical equipment. Such equipment may be sensitive to electromagnetic fields.

A second aspect of the invention provides a wind turbine comprising a hub rotatably supported relative to a nacelle, a plurality of blades rotatably mounted on the hub, and a lightning current transfer system arranged to provide a lightning current transfer path from at least one of the blades to the nacelle,
the lightning current transfer system comprising:
   at least one electrical conductor, wherein the electrical conductor passes through a hollow interior portion of the hub between the at least one of the plurality of blades and the nacelle; and
   a blade current transfer device for maintaining an electrical connection between the at least one of a plurality of blades and the electrical conductor as the blade rotates relative to the hub,
   wherein the blade current transfer device includes a blade band disposed on an interior side of the blade.

Advantageously this arrangement allows for a more compact LCTS by routing the lightning current path through an interior portion of the blade. Further, visual inspection may be carried out on the lightning current transfer system from within the hub near the blade root as the blade band is disposed on an interior surface of the blade. The blade current transfer device, and an inspector thereof, may therefore be sheltered from environmental conditions.

Preferably, the entire blade current transfer device is disposed on the interior side of the blade.

Preferably, the electrical conductor passes through a hub plate covering an aperture between the hollow interior portion of the hub and the interior side of the blade.

As will be clear to the skilled reader, the first and second aspects may be advantageously combined and may be complementary to each other. Characteristics of the first aspect including the optional preferable features may be advantageously combined with those of the second aspect and vice-versa without departing from the teaching of the present disclosure.

### BRIEF DESCRIPTION OF THE DRAWINGS

Embodiments of the invention will now be described with reference to the accompanying drawings, in which:

FIGS. 1A and 1B are schematic diagrams of a wind turbine;

FIG. 2A is a schematic diagram of a hub;

FIG. 2B is a close-up view of a portion of the hub of FIG. 2A;

FIG. 3 is a close-up view of an interior surface of the hub of FIG. 2A;

FIG. 4 is a close-up view of an interior surface of the blade of FIG. 1;

FIG. 5 shows an electrical conductor;

FIG. 6 shows a cross-sectional view through the electrical conductor of FIG. 5.

### DETAILED DESCRIPTION OF EMBODIMENT(S)

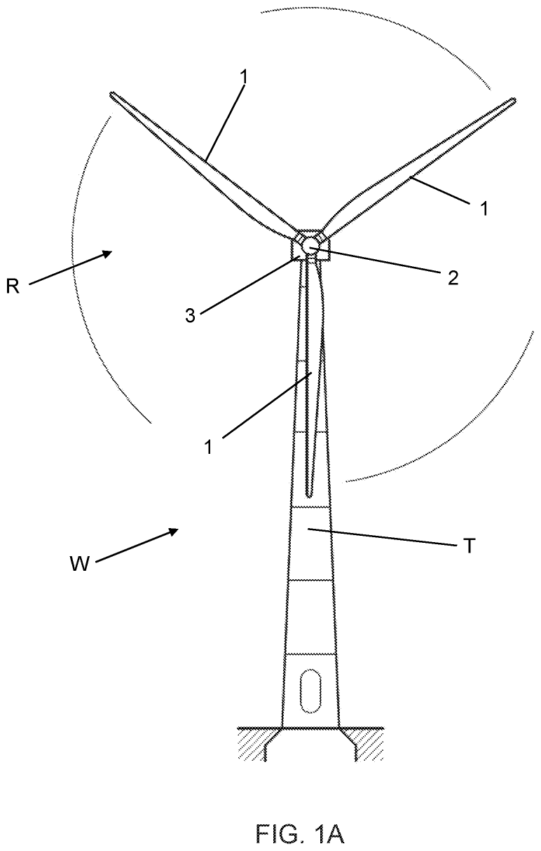

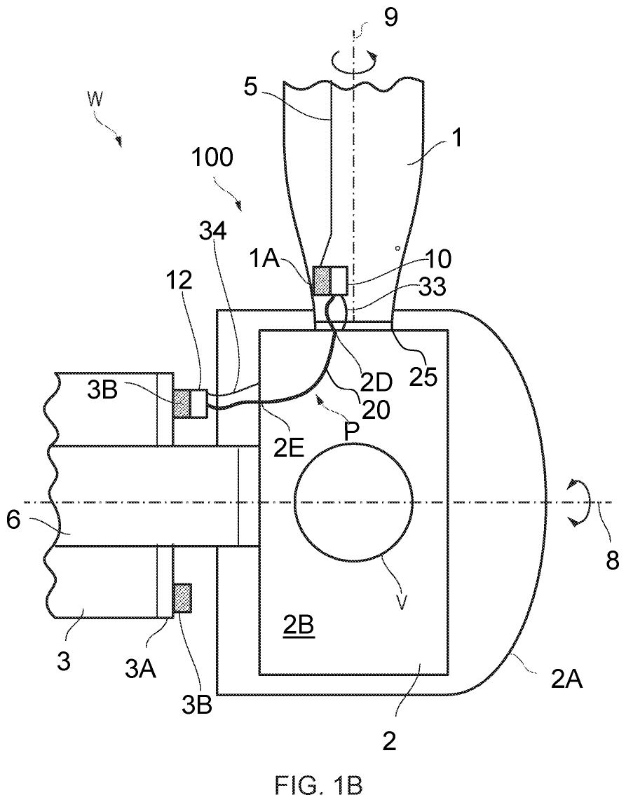

FIG. 1A shows a wind turbine W including a tower T mounted on a foundation and a nacelle 3 disposed at the apex of the tower T. The wind turbine W depicted here is an onshore wind turbine such that the foundation is embedded in the ground, but the wind turbine W may be an offshore installation in which case the foundation would be provided by a suitable marine platform.

A rotor R is operatively coupled to a generator (potentially via a gearbox) (not shown) housed inside the nacelle 3. The rotor R includes a central hub 2 and a plurality of rotor blades 1, which project outwardly from the central hub 2. It will be noted that the wind turbine W is the common type of horizontal axis wind turbine (HAWT) such that the rotor R is mounted at the nacelle 3 to rotate about a substantially horizontal axis defined at the centre at the hub 2. While the example shown in FIG. 1A has three blades, it will be realised by the skilled person that other numbers of blades are possible.

When wind blows against the wind turbine W, the blades 1 generate a lift force which causes the rotor R to rotate, which in turn causes the generator within the nacelle 3 to generate electrical energy.

FIG. 1B illustrates a schematic view of a portion of the wind turbine W with a lightning current transfer system (“LCTS”) 100. The LCTS 100 is arranged to provide a lightning current transfer path P from each of the blades 1, through a respective blade current transfer device and through at least a portion of a hub 2 of the wind turbine W, and further to the nacelle 3 via a nacelle current transfer device as will be described below. The LCTS forms part of a lightning protection system (“LPS”) for the wind turbine. The LPS is provided to direct any lightning current from a lightning strike which may attach to any part of the wind turbine W to ground.

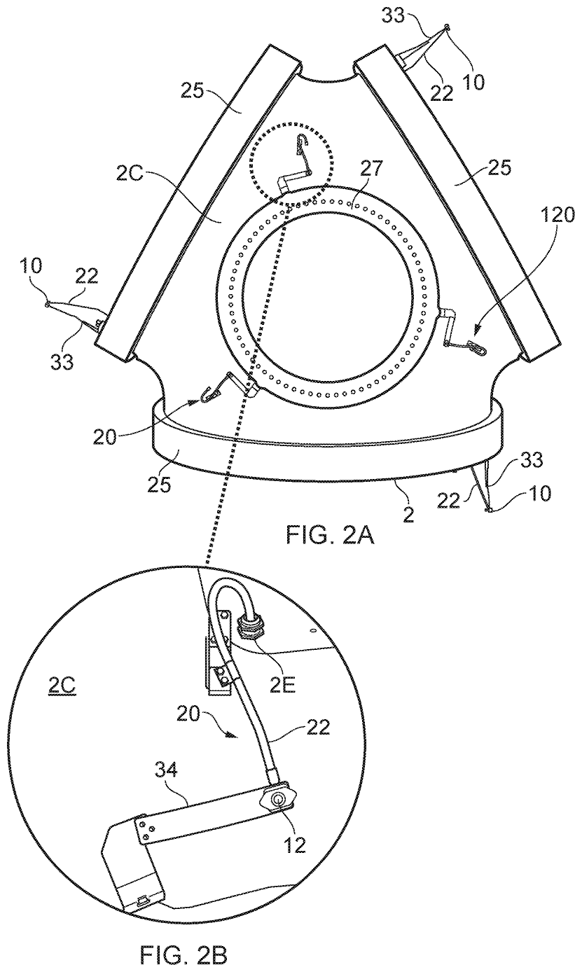

The hub 2 may be covered by a spinner 2A that rotates with the hub 2. The spinner 2A is the aerodynamic housing of the hub 2. The hub 2 may house electrical and mechanical components (indicated by reference letter “V” on FIG. 1B) within a hub cavity 2B. These components V could become damaged if exposed to electro-magnetic interference. The LCTS 100 of the present disclosure is utilised advantageously to reduce this potential outcome, despite routing of the LCTS through the interior of the hub 2. An example hub 2 is shown in FIG. 2A.

The hub 2 is coupled to each of the plurality of blades 1 by respective pitch bearings 25 which permit rotation of the respective blade 1 relative to the hub about the longitudinal axis 9 of the blade. This allows the pitch of blades 1 to be varied.

The hub 2 may be mounted to a main shaft 6 supported by main shaft bearings (not shown) within the nacelle 3 and used to drive the generator as the rotor R rotates. The hub 2 may have a main shaft connection flange 27 for coupling the hub 2 to the main shaft 6. The hub 2 has an aperture inside each of the pitch bearings 25. The hub 2 may have a removable hub plate 40 covering the aperture within each of the pitch bearings 25. The hub 2 may alternatively have no hub plates 40 or the hub plates 40 may be unitary with the rest of hub 2.

The hub 2 and hub plate(s) 40 may be made of metal and therefore act as a Faraday cage. The interior of the hub may be considered a zero electromagnetic compatibility (“EMC”) zone. As such the hub 2 and the hub plate(s) 40 protect components V contained within the hub cavity 2B from outside electromagnetic interference.

Each of the blades 1 may have a portion of the LPS to direct lightning current from any part of the blade 1 towards the root end of the blade adjacent the hub 2. For example, the blade 1 may have a down conductor 5, e.g. in the form of conductive cable.

The LCTS 100 has an electrical conductor 20. The electrical conductor 20 may be electrically connected at a first end thereof to blade 1 by the blade current transfer device 10, 1A forming part of the LCTS 100. The blade current transfer device may be arranged to maintain the electrical connection between a portion of the LPS in blade 1, e.g. the down conductor 5, and the electrical conductor 20 as the blade pitches relative to the hub.

The electrical conductor 20 may be electrically connected at a second end thereof to nacelle 3 by the nacelle current transfer device 12, 3B forming part of the LCTS 100. The nacelle current transfer device is arranged to maintain the electrical connection between the hub 2 and the nacelle 3 as the hub rotates relative to the nacelle.

In the event of a lightning strike to the blade 1, a lightning electrical current may flow through the electrical conductor 20 between the blade current transfer device 10, 1A and the nacelle current transfer device 12, 3B. The connection between the electrical conductor 20 and either of the blade current transfer devices or the nacelle current transfer device may be a direct or indirect connection (that is there may be intermediary components disposed between the electrical conductor 20 and the up/downstream component).

This arrangement forms the lightning current transfer path P that allows lighting electrical current to be transferred from the blade 1 to the nacelle 3 via the electrical conductor 20.

The electrical conductor 20 passes through a hollow interior portion of the hub 2, e.g. as is shown schematically in FIG. 1B. As such the lightning current transfer path P also passes through the hollow interior portion of hub 2.

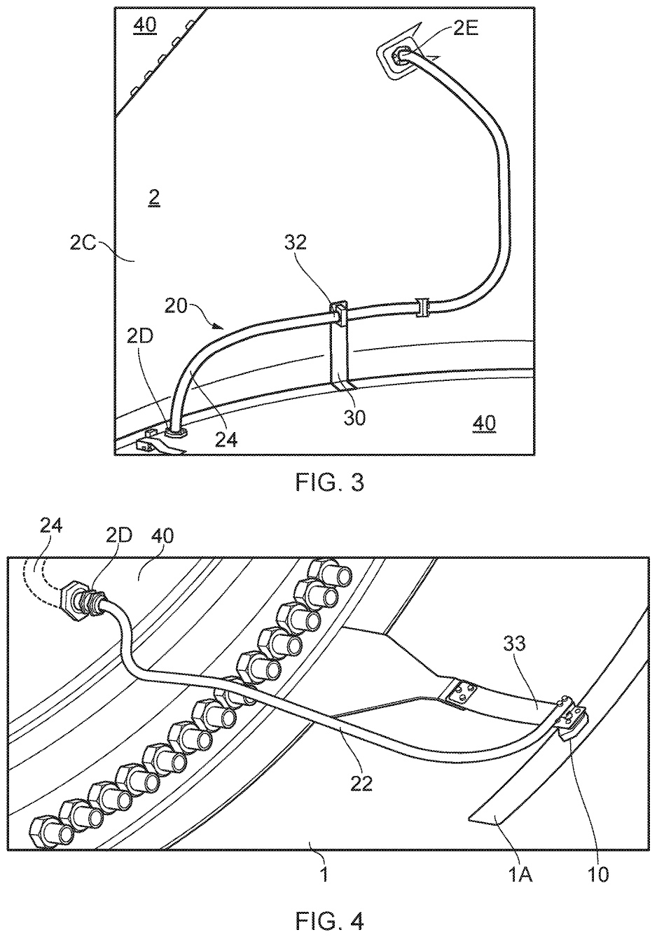

FIG. 3 shows the electrical conductor 20 entering the hollow interior portion of hub 2 near the blade current transfer device 10, 1A (visible in FIG. 4) through aperture 2D and exiting the hollow interior portion of hub 2 near the nacelle current transfer device 12, 3B (visible in FIG. 2B) through aperture 2E in hub 2. Aperture 2D may be formed in hub plate 40 and aperture 2E may be formed in a wall 2C of the hub 2.

The apertures 2D and/or 2E may be perforations in the hub 2, e.g. a perforation in the hub wall 2C and/or the hub plate 40.

The apertures 2D and/or 2E may be small relative to the larger apertures in the hub 2 within each of the pitch bearings 25 or within the main shaft connection flange 27 for example.

The aperture 2D may have electrically insulating material disposed within in it such that the electrically insulating material lies between the aperture 2D and the electrical conductor 20. The aperture 2E may have electrically insulating material disposed within in it such that in use the electrically insulating material lies between the aperture 2E and the electrical conductor 20.

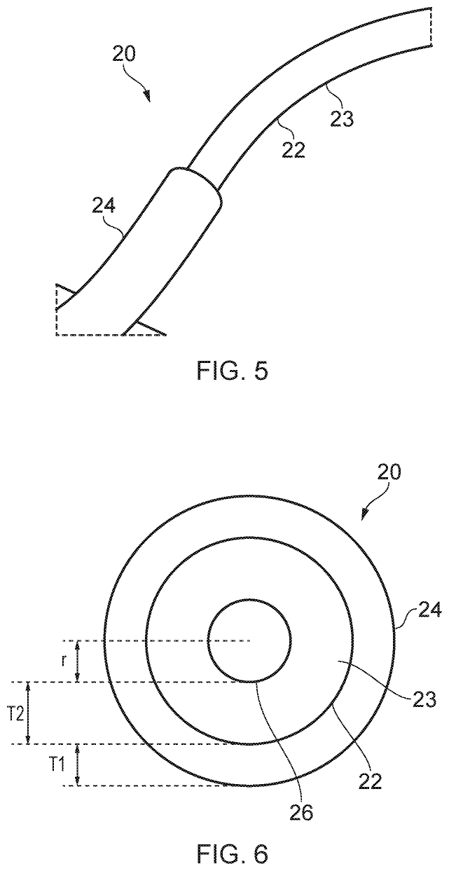

The electrical conductor will now be further explained with the aid of FIGS. 2 to 6. As shown the electrical conductor 20 has a cover 24. The cover 24 is suitable for attenuating an electromagnetic field generated by an electrical current passing through the electrical conductor 20. The attenuation of the electromagnetic field reduces the effect of the electromagnetic field resulting from lightning current passing through the electrical conductor 20 on components located within the hollow interior portion of hub 2 which as described previously acts as a Faraday cage. The cover 24 acts as an extension of the Faraday cage. In other words, the cover 24 enables a reduction in the magnetic field strength H (kA/m) at a distance measured perpendicular to the current passing through the electrical conductor 20. The cover 24 and hub 2 may be electrically connected.

By providing the cover 24, the distance of the LCTS 100 electrical conductor 20 to sensitive parts such as the electronic equipment V can be reduced, enabling the electrical conductor 20 to be routed through the hollow interior portion of the hub 2. For example, this distance measured from the surface of the cover 24 could be as little as: 1 mm to 200 mm, or 10 mm to 100 mm, or 25 mm to 75 mm, or 40 mm to 60 mm, or any subset/combination thereof. Such an arrangement enables greater freedom to arrange the components within the hub cavity 2B despite the lightning current path P passing therethrough. As a non-limiting example, the field strength at a point outside the cover 24 when a lightning current passes through the electrical connector 20 could be 0.0001 to 10 kA/m, or 0.001 to 0.1 kA/m or 0.001 to 0.01 kA/m.

An example of the electrical conductor 20 having the cover 24 is shown in cross-section in FIG. 6. The electrical conductor 20 may be made up of an insulated cable 22 and the cover 24. The insulated cable 22 may have a conductor 26 of radius r, suitable for conducting very high electrical currents which is wrapped, coated or covered by a sheath 23 having a wall thickness T2. The sheath 23 may be an insulating sheath that electrically insulates the cover 24 from the conductor 26. Alternatively, a sheath 23 may not be present if a sufficient gap (such as an air or vacuum gap) is maintained between the cover 24 and the conductor 26. Alternatively insulating foam may be utilised.

The cover 24 may be made from an electrically conducting material. The cover 24 may have a wall thickness of T1 as shown in FIG. 6. The cover 24 may be a pipe (as shown in FIG. 3) or duct or may be a portion of a wall of the hub 2 itself such that the cover 24 is continuous/contiguous with the hub 2. The thickness T1 of the cover 24 may be of a thickness suitable to enable the attenuation of the electromagnetic field of the current passing along the length of the insulated cable 22. The thickness T1 of the cover 24 is preferably: 0.1 mm to 15 mm, or 1 mm to 10 mm, or 2 mm to 8 mm, or 3 mm to 7 mm, or 4 mm to 6 mm, or 5 mm, or any subset or combination thereof.

The cover 24 may be made from a metal such as steel. The steel may be a mild steel, carbon steel or stainless steel. Preferably the cover 24 is made from mild steel.

The cover 24 is preferably coaxial with the conductor 26.

The conductor 26 is preferably made of copper or a copper alloy or another material suitable for transferring high currents. The insulating sheath 23 may be made of polyethylene or any other suitable insulating material, the sheath may comprise one or more layers of insulating material.

The insulated cable 22 is preferably a high-voltage-resistant insulated down conductor suitable for conducting lighting power through it.

The electrical conductor 20 may pass through the hub plate 40 at the previously described aperture 2D and then traverse across the inside surface of the hub cavity 2B, e.g. as shown in FIG. 3. The electrical conductor 20 may be retained in place via a suitable fixture (such as clamps or holders 32) disposed on one or more brackets 30 which are attached to the hub 2 or the hub plate 40. Alternatively, a portion of the electrical conductor 20 may traverse across a portion of the inside surface of the hub cavity 2B such that only that portion of the electrical conductor 20 follows the inside surface of the hub cavity 2B, and other portion(s) of the electrical conductor 20 may traverse away from the inside surface of the hub cavity. Alternatively, the electrical conductor 20 may extend between the previously described aperture 2D and the previously described aperture 2E away from the inside surface of the hub cavity. In any of the above examples where the electrical conductor 20, or a portion thereof, may traverse the hub cavity away from the inside surface thereof, the electrical conductor may maintain substantially a set distance from the inner surface of the hub cavity 2B, or the distance between the inner surface of the hub 2B and the electrical conductor 20 may change along the length of the electrical conductor 20. The electrical conductor 20 may follow in a straight, curved, bent, undulating fashion between the two apertures 2D, 2E.

The cover is preferably uninterrupted within the interior portion of the hub between the two apertures 2D, 2E. This means that there are no breaks in the cover.

The cover 24 may be unitary. Providing a unitary cover helps to attenuate the electromagnetic field by ensuring that there are no breaks in the cover. Alternatively, the cover 24 may be made up of two or more cover parts which when connected together form a cover 24. This may ease manufacturing as the cover can be provided in shorter lengths. The cover parts may be held together by appropriate fixtures or fittings so that the cover is uninterrupted within the interior portion of the hub between the two apertures 2D, 2E. Alternatively, the cover 24 may be continuous with the hub 2 such that the cover 24 is a part of the hub 2 casting itself such as an integral duct or pipe in the hub 2 casting. This provides a single element which helps to attenuate the electromagnetic field

The cover 24 may be connected to the hub 2 at the apertures 2D, 2E such that the covers 24 completely surround said apertures 2D, 2E on the inside of the hub 2. This arrangement may advantageously maintain the Faraday cage, preventing electromagnetic fields inside the hub 2 whilst enabling a shorter lightning current transfer path P through the hub 2. This arrangement may be achieved by means of a flange or other such portion of the cover 24 which overfits the aperture 2D, 2E.

The cover 24 is preferably not present outside of the hub 2. The cover 24 may be present solely within the interior hollow portion of hub 2. This arrangement may reduce cost and mass of the final assembly. A cover 24 is not required outside of the hub 2 as a zero EMC zone is generally not required outside of the hub 2. The electrical conductor 20 may therefore by only partially covered along its length by the cover 24. The electrical conductor 24 may extend continuously through the apertures 2D, 2E beyond the portion covered by cover 24.

The blade current transfer device 10, 1A will now be described in detail. As the pitch of blades 1 changes the lightning current transfer path P should be maintained such that the path P does not break or become otherwise interrupted when pitch is varied. Lightning electrical current is transferred in such an arrangement via the blade current transfer device which may comprise a first contact device 10 and a blade band 1A on the blade 1.

An example of the first contact device 10 is shown schematically in FIGS. 1B, 2A and 4. The first contact device 10 is disposed at a first end of the electrical conductor 20 and faces towards the blade 1. The first contact device 10 may be located outside of the hub 2 as is shown in FIGS. 1B, 2A and 4.

The first contact device 10 may be a sliding contact which in use engages a blade band 1A disposed on the blade 1 of the wind turbine W, as is shown in FIGS. 1 and 4. The blade band 1A is preferably located on an inner surface of the blade 1 (shown in close up in FIG. 4). The blade band 1A may be electrically connected to the down conductor cable 5 of the blade 1. When the blade 1 turns as the pitch is varied the first contact device 10 remains in contact with the blade band 1A.

The blade current transfer device 10, 1A may include an arm 33 upon which the first contact device 10 is directly or indirectly mounted. The arm 33 may be attached in turn to an intermediary bracket (as shown in FIGS. 2A and 4). Arm 33 and/or bracket may be elastically deformable and/or spring loaded such that contact is maintained with the blade band 1A by the first contact device 10. The arm 33 may be made from a non-conducting material such as glass fibre reinforced polymer (GFRP) or other such suitable material with a stiffness suitable to ensure that the first contact device 10 remains engaged with the blade band 1A. Electrical isolation of the hub 2 from lightning path P is achieved, at least in part, by the arm 33. The bracket may be mounted on the hub 2 using a suitable fixture, for example a nut and bolt arrangement. The bracket may be directly mounted to the hub 2 as shown in FIGS. 2A and 4 or the bracket may be indirectly mounted to the hub 2. The bracket may be made of metal and/or may be electrically connected to the hub 2. In alternative configurations the arm 33 may be directly or indirectly mounted to the hub 2 without a bracket.

In an alternative configuration, the blade band 1A may be disposed on an outer surface of the blade 1 and the first contact device 10 may also be disposed outside of the blade 1. In this alternative configuration, the electrical conductor 20 may enter the hollow interior portion of hub 2 via an aperture formed in the wall 2C of the hub 2 and not via the hub plate 40. In all other respects the electrical conductor 20 and the path P may be as described previously.

The nacelle current transfer device 12, 3B will now be described. As hub 2 rotates relative to the nacelle 3 the nacelle current transfer device 12, 3B maintains the electrical connection between the electrical conductor 20 and other parts of the LPS in the nacelle 3. Lightning electrical current is transferred in such an arrangement via the nacelle current transfer device which may comprise a second contact device 12 and a nacelle contact device 3B on the nacelle 3. The nacelle contact device 3B shown schematically in cross-section in FIG. 1B may be a ring. The ring shaped nacelle contact device 3B enables electrical contact to the second contact device 12 as the hub 2 rotates around axis 8 relative to the (stationary) nacelle in use. Alternatively, the parts of the nacelle current transfer device may be reversed such that the (rotating) ring part is mounted on the hub 2 or spinner 2A and the nacelle has the (stationary) contact device part facing the ring part.

An example of the second contact device 12 is shown in FIGS. 1B, 2A and 2B. The second contact device 12 may transfer lightning electrical current away from the hub 2 to a nacelle contact device 3B on the nacelle 3, shown schematically in FIG. 1. The nacelle contact device 3B is located on a nacelle front plate 3A. The second contact device 12 may be slidably connected to the nacelle contact device 3B. Maintenance of the electrical connection is achieved by maintaining the sliding connection between the nacelle contact device 3B and the second contact device 12. As shown in FIGS. 2A and 2B the second contact device 12 may be located on an arm 34 which may be attached in turn on an intermediary bracket. The arm 34 and/or the bracket may be elastically deformable and/or spring loaded such that contact between the second contact device 12 and nacelle contact device 3B is maintained. The arm 34 may be made from a non-conducting material such as glass fibre reinforced polymer (GFRP) or other such suitable material with a stiffness suitable to ensure that the contact 12 remains engaged with the nacelle contact device 3B. Electrical isolation of the hub 2 from lightning path P is achieved, at least in part, by the arm 34. The bracket may be mounted on the hub 2 using a suitable fixture, for example a nut and bolt arrangement. The bracket maybe directly or indirectly mounted to the hub 2. The bracket may be made of metal and/or may be electrically connected to the hub 2. In alternative configurations the arm 34 may be directly or indirectly mounted to the hub 2 without a bracket.

The hub 2 may have a frontal area larger than a frontal area of the nacelle 3. In other words the area of the nacelle 3 facing the hub 2 has a smaller area than the portion of the hub 2 facing the nacelle 3. This is shown schematically in FIG. 1. The nacelle current transfer device 12, 3B may be located within or on the frontal area of the nacelle 3. Alternatively, the frontal area of the nacelle 3 may be larger than the frontal area of the hub 2, or the frontal area of both components may be the same.

Although the invention has been described above with reference to one or more preferred embodiments, it will be appreciated that various changes or modifications may be made without departing from the scope of the invention as defined in the appended claims.

1. A wind turbine (W) comprising a hub (2) rotatably supported relative to a nacelle (3), a plurality of blades (1) mounted on the hub (2), and a lightning current transfer system (100) arranged to provide a lightning current transfer path (P) from at least one of the blades (1) to the nacelle (3),
the lightning current transfer system (100) comprising:
at least one electrical conductor (20), wherein the electrical conductor (20) passes through a hollow interior portion of the hub (2) between the at least one of the plurality of blades (1) and the nacelle (3); and
a cover (24) suitable for attenuating an electromagnetic field generated by a lightning current in the electrical conductor (20) passing within the hollow interior portion of the hub.

2. A wind turbine (W) according to claim 1, wherein the cover (24) comprises electrically conductive material.

3. A wind turbine (W) according to claim 1 or claim 2, wherein the cover (24) comprises or consists of mild steel.

4. A wind turbine according to claim 2 or claim 3, further comprising electrically insulative material between the electrical conductor (20) and the cover (24).

5. A wind turbine (W) according to any of claims 2 to 4, wherein the hub (2) comprises electrically conductive material, and the cover (24) and the hub (2) are electrically connected.

6. A wind turbine (W) according to any preceding claim, wherein the hub (2) provides a Faraday cage and the cover (24) provides an extension of the Faraday cage within the hollow interior portion of the hub to accommodate the lightning current transfer path (P).

7. A wind turbine (W) according to any preceding claim, wherein the cover (24) is a metal pipe.

8. A wind turbine (W) according to any preceding claim, wherein the lightning current transfer path (P) passes through a first aperture (2D) in a hub plate (40) or a wall (2C) of the hub (2) at a first hub location and/or passes through a second aperture (2E) in a wall (2C) of the hub (2) at a second hub location.

9. A wind turbine (W) according to claim 8, wherein the cover (24) is uninterrupted within the interior portion of the hub (2).

10. A wind turbine (W) according to claim 8 or claim 9 wherein the cover (24) is connected to the hub (2) at the first aperture (2D) to completely surround the first aperture (2D) and/or to the hub (2) at the second aperture (2E) to completely surround the second aperture (2E).

11. A wind turbine (W) according to any preceding claim, wherein the electrical conductor (20) is electrically isolated from the hub (2).

12. A wind turbine (W) according to any preceding claim, wherein the cover (24) is not present outside the hub (2).

13. A wind turbine (W) according to any preceding claim, wherein each of the plurality of blades (1) are rotatably mounted to the hub, and the lightning current transfer system (100) further comprises a blade current transfer device for maintaining an electrical connection between the at least one of a plurality of blades (1) and the electrical conductor (20) as the blade rotates relative to the hub.

14. A wind turbine (W) according to claim 13, wherein the blade current transfer device includes a blade band (1A) disposed on an interior side of the blade.

15. A wind turbine (W) comprising a hub (2) rotatably supported relative to a nacelle (3), a plurality of blades (1) rotatably mounted on the hub (2), and a lightning current transfer system (100) arranged to provide a lightning current transfer path (P) from at least one of the blades to the nacelle,
the lightning current transfer system (100) comprising:
at least one electrical conductor (20), wherein the electrical conductor (20) passes through a hollow interior portion of the hub (2) between the at least one of the plurality of blades (1) and the nacelle (3); and
a blade current transfer device for maintaining an electrical connection between the at least one of a plurality of blades (1) and the electrical conductor (20) as the blade rotates relative to the hub,
wherein the blade current transfer device includes a blade band (1A) disposed on an interior side of the blade.

16. A wind turbine (W) according to any of claims 13 to 15, wherein the blade current transfer device includes a contact device (10) mounted to the hub (2) via an elastic bracket (33) for pressing the contact device (10) against the blade band (1A).

17. A wind turbine (W) according to any preceding claim, wherein the lightning current transfer system (100) further comprises a nacelle current transfer device for maintaining an electrical connection between the hub and the nacelle as the hub rotates relative to the nacelle, wherein the hub has a frontal area larger than a frontal area of the nacelle and the nacelle current transfer device is located within the frontal area of the nacelle.

18. A wind turbine (W) according to any preceding claim, further comprising electronics within the hollow interior of the hub (2).

19. A wind turbine (W) according to any preceding claim, wherein each blade (1) of the plurality of blades (1) has a respective electrical conductor (20), wherein each of the electrical conductors (20) passes through the hollow interior portion of the hub (2) between the respective blade (1) and the nacelle (3).
